(19) United States
(12) Patent Application Publication
(10) Pub. No.: US 2006/0143844 A1
(43) Pub. Date: Jul. 6, 2006

(54) Walk behind cleaning apparatus

(76) Inventor: John H. Klucznik, Tellford, PA (US)

Correspondence Address: ZACHARY T. WOBENSMITH, III, 6091 Carversville/Wismer Road, P.O. Box 370, Pipersville, PA, 18947-0370, US

(21) Appl. No.: 11/029,935

(22) Filed: Jan. 6, 2005

(51) Int. Cl. B08B 3/00; B08B 3/12; A47L 11/282

(52) U.S. Cl. 15/50.1; 134/117; 134/198; 134/184; 134/174; 15/98; 15/49.1

(57) ABSTRACT

A walk behind battery operated cleaning apparatus for scrubbing, and cleaning carpets, which is self propelled, has a reservoir tank for cleaning solution, and has dual bonnet-type cleaning assemblies at the front thereof which can be in operating or storage position.

### BACKGROUND OF THE INVENTION

1. Field of the Invention

This invention relates to a walk behind cleaning apparatus of the battery operated floor type machine, used for bonnet cleaning, which is self propelled and includes dual floor machine type cleaning assemblies for bonnet cleaning.

2. Description of the Prior Art

Walk behind cleaning apparatus that clean and scrub carpets are known in the art.

Such apparatus are typically of the single cleaning assembly type. While these apparatus are suitable for their intended purpose, due to the rotational aspects of the single cleaning assembly, the apparatus is constantly pulling to one side, necessitating the operator having to constantly fight the apparatus to force it to travel in a direction opposite to the rotational force.

There is therefore a need for an apparatus that can be easily manipulated by the operator in desired directions.

### SUMMARY OF THE INVENTION

This invention relates to a walk behind battery operated cleaning apparatus, which is self propelled, and has dual floor machine type cleaning assemblies for bonnet cleaning.

The principal object of the invention is to provide a battery operated self propelled floor machine type cleaning apparatus.

A further object of the invention is to provide a cleaning apparatus wherein the apparatus has opposed dual bonnet-type cleaning assemblies.

A further object of the invention is to provide a cleaning apparatus that greatly increases production.

A further object of the invention is to provide a cleaning apparatus which is safer to use and operate than conventional apparatus, as it does not have any attached electrical cords.

A further object of the invention is to provide a cleaning apparatus which is easy to use.

A further object of the invention is to provide a cleaning apparatus which can be used to clean floors or carpet.

A further object of the invention is to provide a cleaning apparatus that provides improved cleaning action.

A further object of the invention is to provide a cleaning apparatus that is durable, and has a long service life.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which,

FIG. 1 is a side elevational view of the cleaning apparatus of the invention with the cleaning assemblies in operating position;

FIG. 2 is a view similar to FIG. 1 with the cleaning assemblies in the storage position allowing for bonnet change, or movement when not cleaning.

FIG. 3 is a front view of the apparatus of FIG. 1.

FIG. 4 is a fragmentary plan view of a portion of the steering mechanism of the apparatus; and

FIG. 5 is a view similar to FIG. 4 illustrating an alternate steering mechanism which increases steering leverage, and reduces the turning radius in smaller areas.

It should, of course be understood that the description and drawings herein are merely illustrative, and that various modifications and changes can be made in the structures disclosed without departing from the spirit of the invention.

Like numerals refer to like parts throughout the several views.

### DESCRIPTION OF THE PREFERRED EMBODIMENTS

When referring to the preferred embodiments, certain terminology will be utilized for the sake of clarity. Use of such terminology is intended to encompass not only the described embodiment, but also technical equivalents, which operate and function in substantially the same way to bring about the same result.

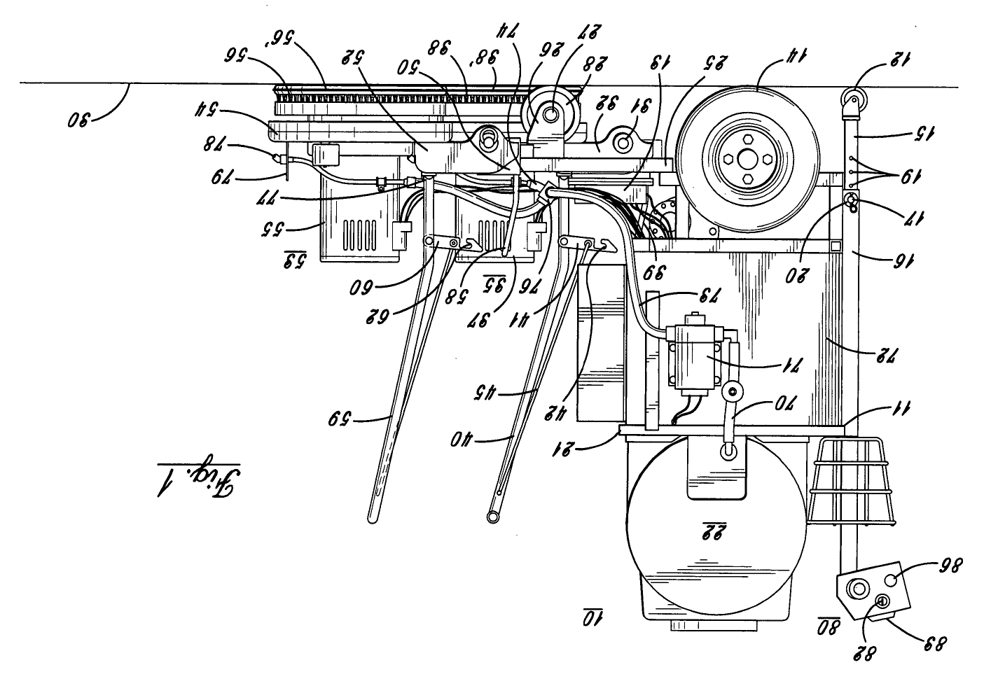

Referring now more particularly to the drawings and FIGS. 1-4, thereof a cleaning apparatus 10 is therein illustrated.

The cleaning apparatus 10 includes a frame 11, with a pair of swivel wheels 12 attached thereto at the rear of the apparatus, with a pair of driven rear wheels 14 attached to frame 11 by a transversely extending transaxle (not shown), in brackets (not shown), which is attached to frame 11, in well known manner.

The transaxle (not shown) includes a reversible driving motor (not shown), of any desired type, with the preferred transaxle available from MCG, Prior Lake, Minn. 55372.

A control box 13 is provided connected to frame 11 and by a cable (not shown) to transaxle motor (not shown) and to a source of electrical energy (not shown), such as deep discharge lead acid electric storage batteries of well known type. The control box 13 controls the speed and the direction of the wheels 14 through the transaxle (not shown), and its motor (not shown). Any suitable control box can be used, with the preferred one available from MCG<Prior Lake, Minn.

The swivel wheels 12 are each carried by a tubular member 15, which telescopes into a frame member 16, which member 15 has a pin 17, and holes 19 therein, with a hole 20 in member 16, providing for vertical adjustment of the member 15.

The frame 11 has an upper shelf 21, which has a reservoir tank 22 thereon, for storage of cleaning solution (not shown), and which is secured to shelf 21 in well known manner.

The frame 11 has a pair of lower plates 25 extending therefrom, carrying an axle 27 therein, with front wheels 28 thereon.

The wheels 12, 14 and 28 are shown in contact with a surface 30 which may be a floor.

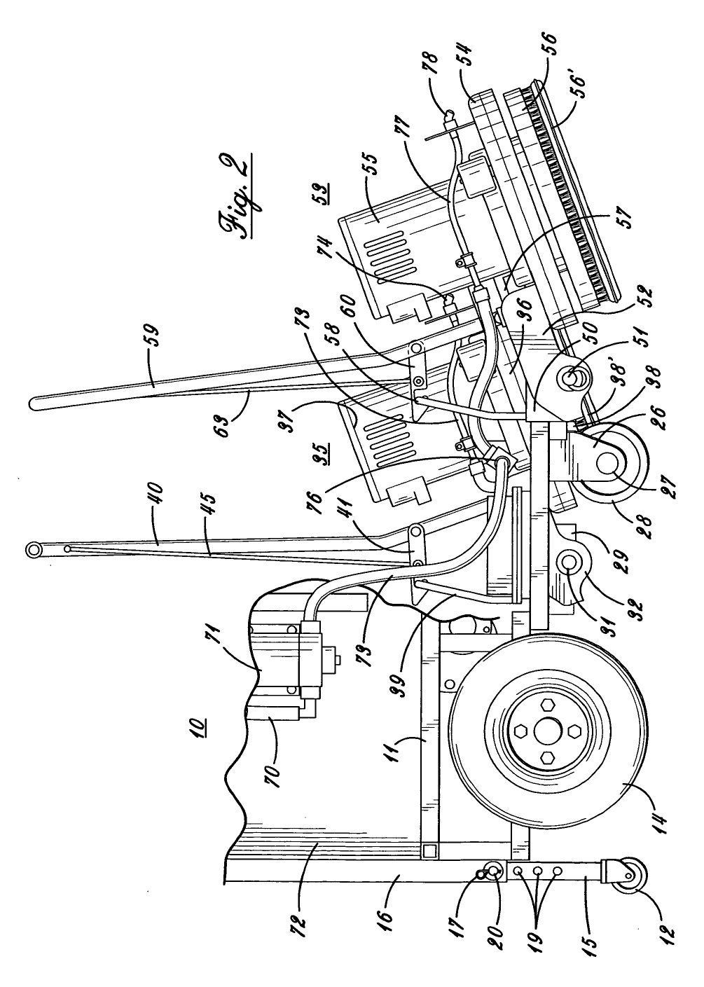

The frame 11 has brackets 29 extending therefrom, which have a shaft 31 engaged therewith, and with deck arm 32 of a rear bonnet cleaning assembly 35. The assembly 35 is offset to the right from the center as seen in FIG. 2, and includes a deck 36, to which the arms 32 are attached, with an electric motor 37 of well known type carried thereon. The motor 37 has a pad holder assembly 38 connected thereto, which includes a pad 38′, which is rotated by the motor 37 to scrub, and clean carpets.

The frame 11 has an upwardly extending U-shaped arm 39 which is welded to frame 11. The deck 36 has an upwardly extending frame 40, which has lift lock 41 pivotedly attached thereto, with a notch 42 for engagement with arm 39, as seen in FIG. 2 to retain cleaning assembly 35 and its pad holder 38 in position off the floor 30.

The lift lock 41 has a rod 45 engaged therewith, extending upwardly which operates lift lock 41, for engagement and disengagement with arm 39, and which rod 45 is retained in bracket 46, which is attached to frame 40 as shown in FIG. 3.

The frame 11 has a forwardly mounted pair of brackets 50, with a shaft 51 extending therebetween, and engaged in arms 52, of a front bonnet cleaning assembly 53, which is offset to the left as seen in FIG. 3.

The assembly 53 has a deck 54, which has the arms 52 attached thereto, with an electric motor 55 of well known type carried thereon. The motor 55 has a pad holder assembly 56 connected thereto which includes a pad 56′ which is rotated by motor 55 to scrub and clean carpets.

The frame 11 has an upwardly extending U shaped arm 58. The deck 54 has an upwardly extending frame 59 connected to arms 52, which has a lift lock 60 pivotedly attached thereto, with a notch 62 for engagement with arm 58, as seen in FIG. 2, to retain cleaning assembly 53, and its pad holder 56 in position off the floor 30.

The lift lock 60 has a rod 63 engaged therewith, extending upwardly, which operates lift lock 60, for engagement and disengagement with arm 58, and which rod 63 as shown in FIG. 3 is retained in a bracket 64, which is attached to frame 59.

Due to their being pivotally mounted to frame 11, the front and rear bonnet cleaning assemblies 35 and 53, are able to float as they travel over a surface 30 to be cleaned, conforming to any unevenness in the surface.

The reservoir tank 22 has a hose 70 attached thereto, and to an electrically driven pump 71, carried on a panel 72 which is mounted to shelf 21. The pump 71 has an output hose 73, which extends to a nozzle 74 for the rear bonnet assembly 35, and to a fitting 76, from which a hose 77 extends to a nozzle 78, carried by bracket 79 on deck 54 of front bonnet assembly 53. The nozzles 74 and 78 dispense cleaning solution (not shown) ahead of pads 38¹ and 56¹, and pad holders 38 and 56.

The frame 11 has a steering column 80 attached thereto, with a cleaning solution on-off switch 81, a key switch 82 to activate the apparatus 10, and an on-off switch 83 to activate motors 37 and 55, to rotate the pad holders 38 and 56 and pads 38¹ and 5¹. The column 80 has a left handle 85, and a right handle 86 extending therefrom for steering the apparatus 10 by an operator (not shown). Batteries (not shown) and wiring (not shown) are provided, carried by frame 11, and which provide the electrical power to operate pump 71, motors 37 and 55, and transaxle motor (not shown) to drive wheels 14 to propel the apparatus 10 forward and reverse.

A U shaped forward and reverse thumb lever or throttle 90 is provided, pivotally mounted to column 80, which if pressed on the right causes control box 13 to activate wheels 14 to move forwardly, and if pressed on the left to move rearwardly, with the speed being controlled by the degree of displacement of throttle 90. If the throttle 90 is released, the transaxle motor (not shown) will slow down and brake the apparatus 10 as required.

The column 80 has a momentary button 81 thereon for finer control of the water pump 71 and momentary dispensing of the cleaning solution (not shown).

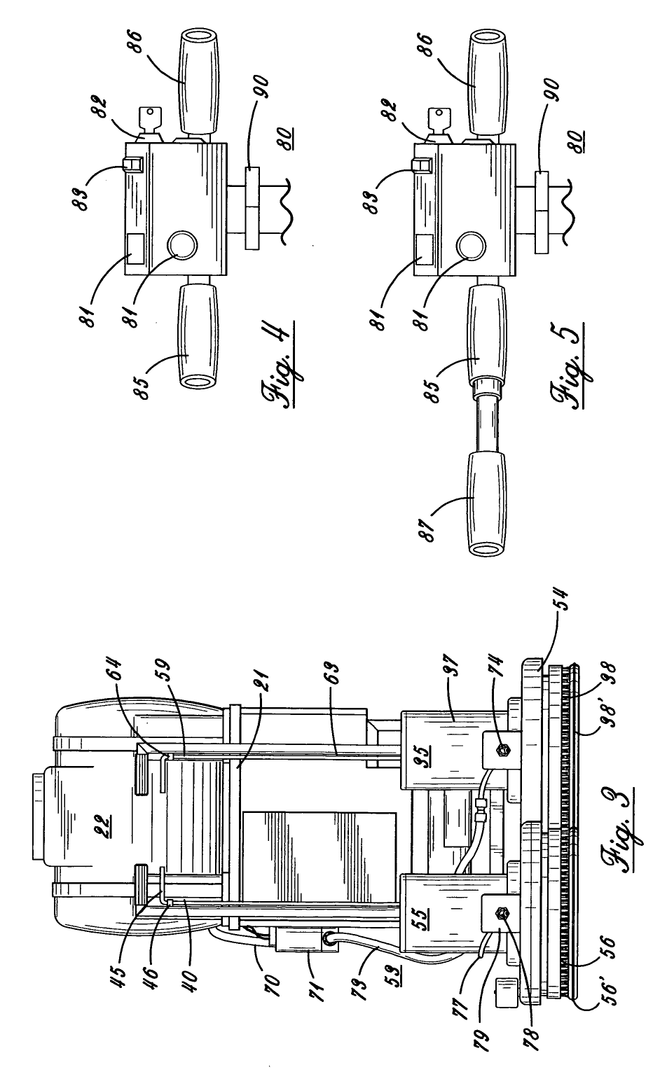

Referring now to FIG. 5, an alternative steering arrangement is provided, which is identical to that shown in FIG. 4, except that the left handle 85 is provided with an extension 87, which is detachably engaged with handle 85 in well known manner, and provides for improved control of the apparatus 10.

It will thus be seen that apparatus has been provided with which the objects of the invention are achieved.

I Claim:

1. A walk behind cleaning apparatus which comprises a frame;
front and rear wheels carried by said frame;
said rear wheels being mounted to a transaxle means which is attached to said frame;
said transaxle means including electric motor means for driving said rear wheel,
a pair of swivel wheels carried by said frame;
adjustment means to adjust the vertical height of said swivel wheels, a steering column carried by said frame;
at least two handles carried by said steering column for controlling the direction of travel of said apparatus;
first attachment means connected to said frame;
an electric motor driven rear bonnet cleaning assembly mounted to said first attachment means;
positioning means connected to said attachment means and said rear bonnet cleaning assembly for positioning it for operation or for storage;
said rear bonnet cleaning assembly being offset from the center of said apparatus;
second attachment means extending forwardly from and connected to said frame,
an electric motor driven front bonnet cleaning assembly mounted to said second attachment means;
positioning means connected to said second attachment means and said front bonnet cleaning assembly for positioning it for operation and storage;
said front bonnet cleaning assembly being offset from the center of said apparatus opposite to said rear bonnet cleaning assembly,
electrical supply means carried by said frame to supply electrical energy to said electric motors,
and control means to control the electrical energy supplied to said electric motors.

2. A walk behind cleaning apparatus as defined in claim 1 in which:
a reservoir tank is provided carried on said frame;
hose means connected to said tank;
pump means connected to said hose means, and
nozzle means connected to said hose means for delivering liquid to said floor ahead of said bonnet cleaning assemblies.

3. A walk behind cleaning apparatus as defined in claim 2 in which, said electrical supply means providing electrical energy to said cleaning assemblies, said drive system, and said pump means is at least one electric storage battery.

4. A walk behind cleaning apparatus as defined in claim 1 in which,
said cleaning assemblies include a deck;
an electric motor mounted to said deck, and
a pad holder assembly connected to and driven by said motor, and wherein
said attachment means permit said bonnet cleaning assemblies to float.

5. A walk behind cleaning apparatus as defined in claim 1 in which,
said positioning means includes retainer assemblies carried on said frame, and
catch means on said cleaning assemblies to engage said retainer assemblies for positioning of said brush assemblies for operating and storage.
